(19) United States
(12) Patent Application Publication
(10) Pub. No.: US 2025/0103807 A1
(43) Pub. Date: Mar. 27, 2025

(54) COMPUTER-IMPLEMENTED METHOD FOR SHAFT CLASSIFICATION OF AN ENTITY BASED ON WEBSITE CONTENT

(71) Applicant: Klaviyo, Inc., Boston, MA (US)

(72) Inventor: Zachary Lloyd Roth Willert, Newton, MA (US)

(21) Appl. No.: 18/888,615

(22) Filed: Sep. 18, 2024

Related U.S. Application Data
(60) Provisional application No. 63/584,980, filed on Sep. 25, 2023.

(51) Int. Cl. G06F 40/279; G06F 40/205

(52) U.S. Cl. CPC G06F 40/279; G06F 40/205

(57) ABSTRACT

A computer-implemented method for classifying prohibited entities gathers text from the entity's website and applies a trained machine learning model to score at least one prohibited category for each entity based on the text gathered from the entity's website. In variations of the invention, each of a plurality of different prohibited categories are scored, and the entity is classified according to the category having the highest score. The machine learning model is trained through multiple stages using a comprehensive data set. Related computer systems are described.

### CROSS REFERENCE TO RELATED APPLICATIONS

This claims priority to provisional patent application No. 63/584,980, filed Sep. 25, 2023, entitled “COMPUTER-IMPLEMENTED METHOD FOR SHAFT CLASSIFICATION OF AN ENTITY BASED ON WEBSITE CONTENT”, the entirety of which is incorporated herein by reference for all purposes.

### TECHNICAL FIELD

This generally relates to text classification, and more particularly to classifying an entity based on the content of its website.

### BACKGROUND

Various regulations and policies prohibit advertising certain categories of goods using Toll Free Numbers (TFN) and short message service (SMS) messaging. Examples of prohibited categories include items, services or content related to sex, hate, alcohol, firearms, tobacco, and cannabis (hereinafter collectively referred to as the “SHAFT” categories). The consequences of violating one of these regulations can be severe, and include fines or federal sanctions from using a communications technology. Every entity involved in using TFN or SMS for advertising has a substantial incentive to prevent SHAFT-related content. It is thus desirable to identify or verify entities that are involved in marketing SHAFT-related goods and services.

Asking an entity during a signup process whether it markets prohibited goods is an approach that relies on the entity being responsive and accurate. Such self-reporting approaches, however, are subject to error for a number of reasons, not the least of which is providing incomplete or inaccurate responses.

Manually investigating the entity requires employee time, is subject to human error, is inefficient, and perhaps most importantly, is not scalable for mass entity classification. A human reviewer may need one minute or more to review a single entity.

Accordingly, a method and system that addresses the above-mentioned challenges is desired.

### SUMMARY OF THE INVENTION

A computer system is programmed and operable to classify whether an entity is involved in selling or marketing prohibited goods and services related to sex, hate, alcohol, firearms, tobacco, and cannabis.

In embodiments of the invention, the system is programmed and operable to classify the entity using a trained machine learning model based on the content automatically gathered from the entity's website.

In embodiments of the invention, the trained model is a decision tree-based model, and in preferred embodiments, a gradient boosting model or extreme gradient boosting model.

In embodiments of the invention, the system is programmed and operable to compute a score for a plurality of categories including a score for each prohibited category for the entity.

In embodiments of the invention, the text is scraped from the website and excludes the non-text information in the HTML code.

In embodiments of the invention, the text is scraped using a website scraper, and in some embodiments, the text is scraped using the Python or TypeScript scraper.

In embodiments of the invention, the text is parsed, and in some embodiments, the text is parsed using the Beautiful Soup Parser.

In embodiments of the invention, the text is vectorized. In some embodiments, the text is vectorized using word count methods such as term frequency-inverse document frequency (TF-IDF), or embedding methods such as bidirectional encoder representations from transformers (BERT).

In embodiments of the invention, the vectorized text is sent to the trained model to compute a score for each of the plurality of categories.

In embodiments of the invention, each score is a probability, optionally between 0-1 or 1-100, and wherein the sum of all the scores equals 1 or 100 respectively.

In embodiments of the invention, the system is programmed and operable to classify the entity according to the category having the highest score.

In embodiments of the invention, the system is programmed and operable to classify the entity as a shaft entity, a non-shaft entity, an unknown entity, or empty.

In embodiments, an entity account is classified as ‘empty’ if the website is not live (e.g., empty of products/relevant content).

In embodiments of the invention, the system is programmed and operable to store the entity, category, and score.

In another embodiment of the invention, a computer-implemented method of training a production model to classify prohibited entities comprises: gathering text from a plurality of different entity websites; preparing a first data set for a first stage of training by labeling a portion of the websites with a category from a group of prohibited categories; providing at least one candidate label-assist model; training the at least one candidate label-assist model during the first stage using the first data set to predict a category and a confidence score for each of the plurality of websites; creating a second data set for a second stage of training by identifying and relabeling all the websites having high confidence scores greater than a threshold value (e.g., labeling the cannabis website or another category if the confidence score is greater than 80%) with the predicted category; and training the at least one candidate label-assist model in a second stage using the second data set.

In embodiments of the invention, the first data set comprises greater than 7000 different websites.

In embodiments of the invention, the computer-implemented method further comprises saving the second data set.

In embodiments of the invention, the at least one candidate label-assist model comprises a plurality of candidate label-assist models, wherein the plurality of candidate label-assist models comprises different types of machine learning models.

In embodiments of the invention, the computer-implemented method further comprises selecting a production model from the plurality of candidate label-assist models based on the candidate label-assist model predicting categories having the highest accuracy.

In embodiments of the invention, the computer-implemented method further comprises comparing the predicted categories computed by the plurality of candidate label-assist models for matching.

In embodiments of the invention, the computer-implemented method further comprises creating a third data set by labeling the websites with the predicted categories if the predicted categories computed by each of the plurality of candidate label-assist models match, and training the at least one candidate label-assist model during a third stage with the third training set.

In embodiments of the invention, the computer-implemented method further comprises identifying disputed-category websites where the predicted categories computed by each of the plurality of candidate label-assist models do not match.

In embodiments of the invention, the computer-implemented method further comprises creating a fourth data set by relabeling the disputed websites, and training the at least one candidate label-assist model during a fourth stage with the fourth training set.

In embodiments of the invention, the computer-implemented method further comprises identifying at least one low count category, and creating a fifth data set by labeling or relabeling the entities to increase the number of entities in the at least one low count category, and training the at least one label-assist model during a fifth stage with the fifth data set.

In embodiments of the invention, the low count category is defined as a category made up of less than 10% of the labeled entities, or where no further data points can be found using text searching or model-assisted techniques.

In embodiments of the invention, the computer-implemented method further comprises identifying edge data points having computed confidence scores below 50%, and creating a sixth data set for sixth stage of training by relabeling the edge data points, and training the at least one label-assist model during a sixth stage with the sixth data set.

In embodiments of the invention, the trained production model is decision tree based.

In embodiments of the invention, the trained production model is gradient boosting, and in some embodiments, extreme gradient boosting model.

In embodiments of the invention, the computer-implemented method further comprises fetching and parsing the text from the websites, and in some embodiments the parsing is performed by Beautiful Soup.

In embodiments of the invention, the computer-implemented method further comprises vectorizing the parsed text, and in some embodiments vectorizing is performed by TF-IDF.

In embodiments of the invention, the total feature/word count is limited to less than 5000, and preferably less than 4000 words, and in some embodiments less than 500.

In embodiments of the invention, the minimum document frequency that a word is used as a feature is set to range less than 0.1%; and the maximum document frequency that a word is used as a feature is set to range between 25 to 75% and more preferably between 33 to 66% and in preferred embodiments between 40-50%, or between [0.40-0.50].

In embodiments of the invention, the system and computer implemented method predict the scores of the categories of the entity's website without use of the text from the entity's email or SMS, and optionally, the category is predicted based solely on the text of the entity's website.

In embodiments of the invention, one or more non-transitory computer-readable media or product having instructions stored thereon that, when executed by one or more processors of a computing device, cause the one or more processors to perform operations comprising: generating, using at least one machine learning label-assist model through multiple training stages, a labeled production data set comprising a plurality of different entities, text, and a label for each entity; training a machine learning production model using the labeled production data set; and classifying an unlabeled entity according to a prohibited category based on automatically gathering text from the entity's website and the trained machine learning production model.

A meaningful advantage of embodiments of the present invention is that the classifying process is computer implemented and automatic-the system and method do not request (or require) additional information from the entity in order to evaluate its website. In contrast, relying on the entity to send SMS or an email for categorizing the entity can be thwarted if the entity is slow to respond, or worse, does not respond at all.

Other aspects and advantages of the present subject matter will become apparent from the following detailed description taken in conjunction with the accompanying drawings, which illustrate, by way of example, the principles of the present subject matter.

### DESCRIPTION OF DRAWINGS

The present subject matter is illustrated by way of example, and not by way of limitation, in the figures of the accompanying drawings in which:

FIG. 1 shows a schematic diagram of a SHAFT classifying system, according to one or more embodiments of the present invention;

FIG. 2 is a flow chart of a training process, according to one or more embodiments of the present invention;

FIG. 3 is a flow chart of a data gathering process, according to one or more embodiments of the present invention;

FIG. 4 is a flow chart of a data labeling process, according to one or more embodiments of the present invention;

FIG. 5 is a flow chart of a model training process, according to one or more embodiments of the present invention;

FIGS. 6-7 are charts illustrating results of a various models, according to one or more embodiments of the present invention;

FIG. 8 is a flow chart of a classifying process, according to one or more embodiments of the present invention;

FIG. 9 is a flow chart of another classifying process, according to one or more embodiments of the present invention; and

FIG. 10 is a block diagram of a computing system that can implement techniques described herein, according to one or more embodiments of the present invention.

### DETAILED DESCRIPTION

Before the present invention is described in greater detail, it is to be understood that this invention is not limited to particular embodiments described, and as such can, of course, vary. It is also to be understood that the terminology used herein is for the purpose of describing particular embodiments only, and is not intended to be limiting, since the scope of the present invention will be limited only by the appended claims. Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges can independently be included in the smaller ranges and are also encompassed within the invention, subject to any specifically excluded limit in the stated range. Where the stated range includes one or both of the limits, ranges excluding either or both of those included limits are also included in the invention. Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described. It is noted that, as used herein and in the appended claims, the singular forms “a”, “an”, and “the” include plural referents unless the context clearly dictates otherwise. It is further noted that the claims can be drafted to exclude any optional element. As such, this statement is intended to serve as antecedent basis for use of such exclusive terminology as “solely,” “only” and the like in connection with the recitation of claim elements, or use of a “negative” limitation. As will be apparent to those of skill in the art upon reading this disclosure, each of the individual embodiments described and illustrated herein has discrete components and features which can be readily separated from or combined with the features of any of the other several embodiments without departing from the scope or spirit of the present invention. Any recited method can be carried out in the order of events recited or in any other order that is logically possible.

All existing subject matter mentioned herein (e.g., publications, patents, patent applications and hardware) is incorporated by reference herein in its entirety except insofar as the subject matter may conflict with that of the present invention (in which case what is present herein shall prevail).

Described herein are various methods and systems for classifying an entity based on website text gathered from the entity.

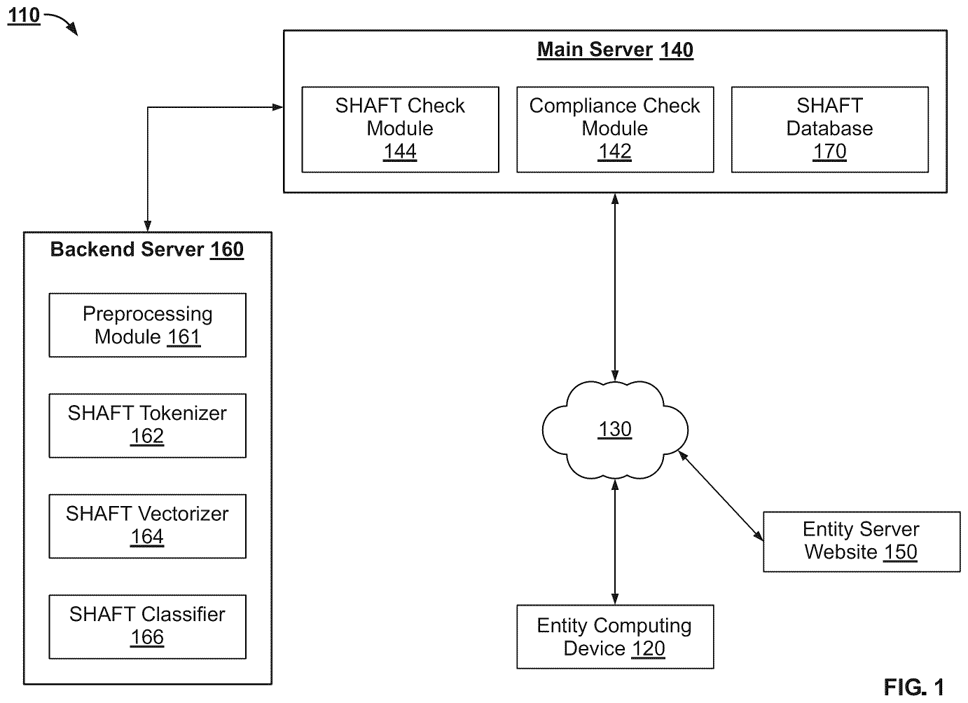

FIG. 1 illustrates a high-level schematic diagram of a SHAFT classifying system 110 for classifying an entity (e.g., a business, organization, association, institution, etc.) based on its website, according to embodiments of the present invention.

The system shown in FIG. 1 includes a main server 140 comprising a compliance check module 142. The compliance check module 142 is programmed and operable to communicate with an entity computing device 120 (e.g., a desktop or workstation located at the entity's place of business) via the internet 130. When an entity requests to sign up for a service via their computing device 120, the compliance check module obtains information from the entity including its name, date/time, and website address. Optionally, the compliance check module may request additional information including category of business, pending licenses, and principal place of operation.

The compliance check module 142 then automatically scrapes the entity website 150 for further processing, described herein.

The main server 140 also shows SHAFT check module 144. SHAFT check module 144 is programmed and operable to communicate with backend server 160. In embodiments and as described further herein, the main server 140 can scrape the website and send the text of the website to the backend server 160 for processing and classification.

Backend server 160 is shown including a tokenizer 162, vectorizer 164, and classifier 166. As described herein, tokenizer 162 is programmed and operable to tokenize the text received from the SHAFT check module 144.

Optionally, the backend server comprises a preprocessing module 161 that is operable to preprocess the text from the main server by, for example, omitting/stopping certain words, stemming words, and/or changing the case of the letters (e.g., changing all uppercase letters to lowercase letters).

The vectorizer 164 transforms the tokenized text into a vector or numeric format.

The classifier 166 computes a score (e.g., a confidence score) for each category for the entity based on the vectorized text.

The entity is then categorized according to the SHAFT category having the highest score. The backend server sends the classification and score to the main server and the main server records the entity, class, and an associated score onto the SHAFT database 170. The entire process can be performed for an entity in seconds. New entity classification is continuously added to the SHAFT database 170, serving to identify which entities to prohibit from TFN and SMS services.

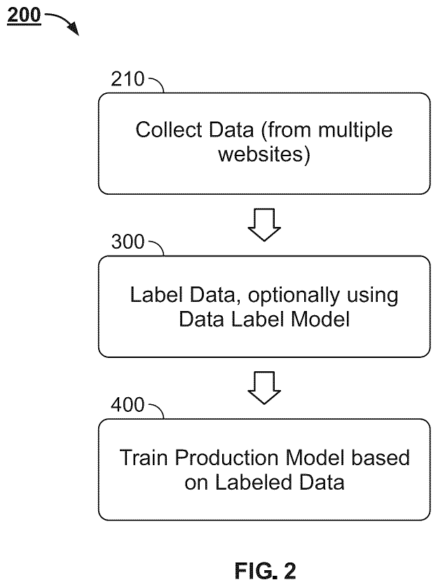

FIG. 2 is a flow chart of a SHAFT classifier training process, according to one or more embodiments of the present invention.

Step 210 states to collect data for training. As described further herein, data is collected from multiple websites.

Step 300 states to label the data. As described further herein, the data is labeled manually or more preferably automatically through multiple stages. Each website is labeled by category based on its website text.

Step 400 states to train the production model based on the labeled data. As desired herein, the production model is trained, tuned and optimized using the comprehensive labeled data set prepared via step 300.

### Data Collecting

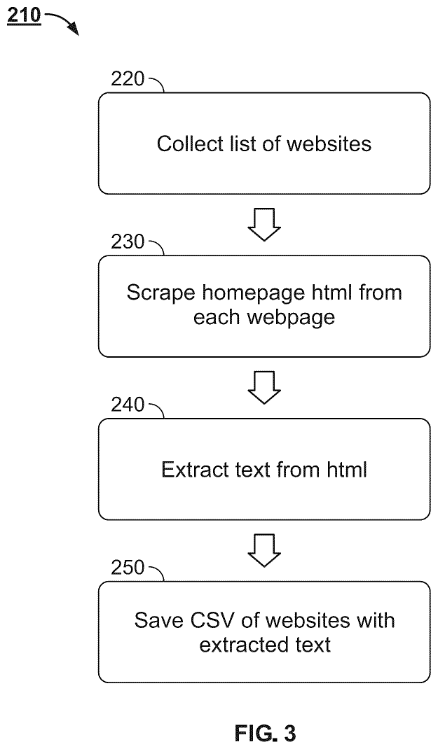

With reference to FIG. 3, the step of data collecting 210 is further described in accordance with an embodiment of the invention. Particularly, FIG. 3 shows data collecting being commenced by collecting a list of websites from a desired population, e.g., customer or businesses of one or more segments (Step 220). In embodiments, text is collected from greater than 5,000, preferably greater than 7,500, and even more preferably greater than 10,000 websites.

Next, each website is scraped (Step 230). Website scraping may be performed by various tools including, e.g., the Python scraper or TypeScript. In embodiments, the homepage or landing page is scraped, however, in other embodiments, multiple pages of the website are scraped.

Next, the text is extracted from the html elements (Step 240).

A CSV file of the websites with the extracted text is then saved (Step 250).

### Data Labeling

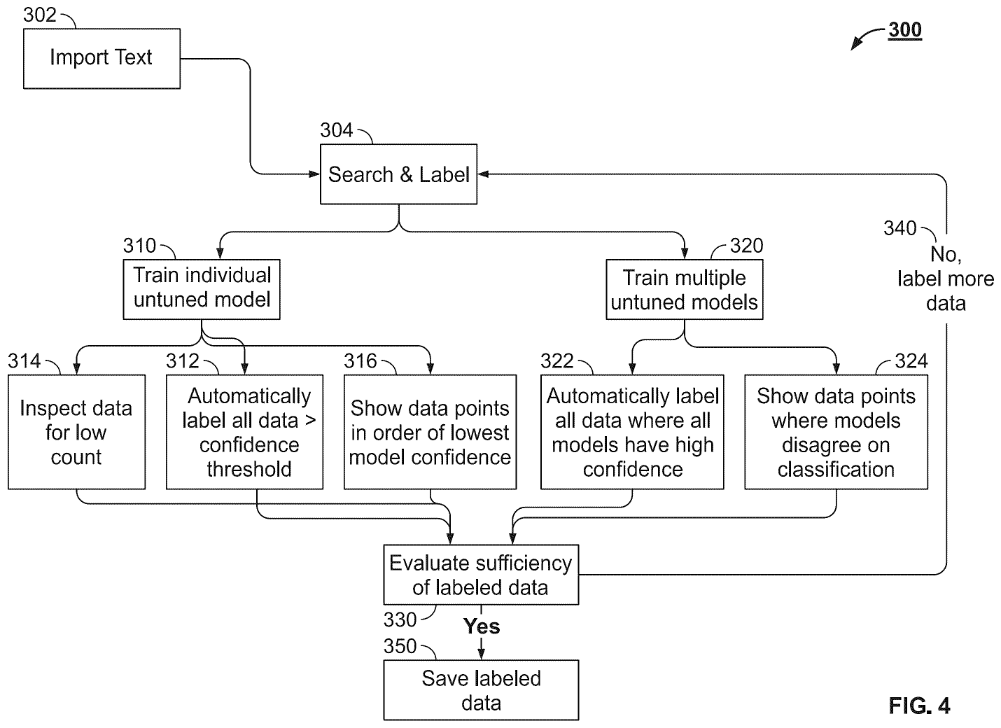

With reference to FIG. 4, the step of data labeling 300 is further described in accordance with an embodiment of the invention. Particularly, FIG. 4 shows data labeling 300 being commenced by importing the text (Step 302). As described herein, this text data may be in the form of a CSV file where each row comprises the entity name, website, and extracted text from the website.

Step 304 states to search for keywords and label individual data points. Each website is labeled based on finding the keywords in the website text. Exemplary labels include each of the SHAFT categories, cannabis, and ‘none’ (i.e., the website is non-SHAFT related).

Step 304 may be performed manually. An individual may search the extracted words for a SHAFT-related word (e.g., marijuana), check the website itself, and individually label the website according to the true category (e.g., cannabis).

In embodiments, a dictionary of the keywords for searching is stored. Examples of keywords include the category itself, as well as plurals and common misspellings.

In a preferred embodiment, and with reference to step 310, an untuned label model is applied to predict categories of the data to be labeled. The types of untuned label models may vary widely. Examples of untuned label models include, without limitation, decision tree-based models, Random Forest with or without gradient boosting, support vector machines (SVM), and logistic regression models. The untuned label model can be initially trained using the labeled data arising from step 304.

Although the untuned label model is not able to accurately predict categories for all the websites, the inventors have found its results can be useful for auto-labeling. In the case of thousands or tens of thousands of data points, auto labeling a portion of the data points is a real advantage.

In the embodiment shown in FIG. 4, and with reference to Step 312, the label model categorizes certain high confidence websites (e.g., where the probability is greater than 90% that the predicted category matches the true category). These high confidence websites can be auto-labeled based on this preliminary untuned label model.

Additionally, with reference to step 316, the untuned label model can show websites having low confidence scores (e.g., where the probability that the predicted category matches the true category is less than 50%). Low confidence scores arising from the marginal or edge data points are of high value for model training purposes. As described further herein, the edge data points are preferably manually labeled and the models are retrained using the additional edge data points. In embodiments of the invention, the data points are shown in order from the lowest to highest model confidence.

Additionally, in embodiments, with reference to step 314, categories are identified having small or low data counts. That is, categories are identified which ought to have more examples to ensure the prediction is accurate. In such instances, the data points are reviewed to identify any low count category. Additional keywords related to the low count category are searched in order to add more example data points to the low count category.

In embodiments, and with reference to step 320, a plurality of different-types of untuned label models are applied to predict categories of the data to be labeled. The different types of untuned label models can be the same as those described above in connection with step 310. Each of the untuned label models can be trained using the labeled data arising from step 304.

With reference to Step 322, when all the label models predict the same category for a website, a high confidence is assigned to this label for the website. These high confidence labels can be automatically applied to the associated websites based on these preliminary untuned label models.

Additionally, with reference to step 324, when all the label models disagree on predicting the same category for a website, we infer the data point has a low confidence score and is an edge type case. The marginal or edge data points arising from disputed classifications are of high value for model training purposes. As described further herein, the edge data points are preferably manually labeled and the models are retrained using the additional edge data points.

Step 330 states to evaluate sufficiency of the labeled data. This step can be performed by evaluating category counts to see which categories can be benefitted by more examples. For example, where a category count makes up less than 10% of the total data points (a relatively low count), the accuracy of the model may be suspect and not able to accurately classify new real websites properly because the labeled training data set is too small. When the training data set is too small, the model essentially evaluates itself on the limited data trained. For example, if the model is trained on a few websites that have the word “beer,” and the model predicts with 100% accuracy such websites are classified as alcohol categories, the model may still be a poor performer. The model may mis-categorize, for example, a website that only lists tequila because tequila was not in the training data. Thus, step 330 serves to identify low data count categories to which more examples are added.

To add more examples to the low count category, the website text is further searched using additional keywords related to the low count category. For example, with reference to the “beer” store example described above, the text is searched for tequila, rum, and whisky to identify additional websites that ought to be categorized as alcohol. The additional examples are labeled. Then, the models are retrained per Step 340.

Additionally, where the models predict a category with low accuracy (e.g., less than 90% for some categories such as cannabis, or perhaps less than 70% for others such as firearms), such websites can be manually reviewed for their proper category. As described herein, low accuracy predictions or edge cases are of high model training value. After the proper category is identified for the edge case, it is relabeled per Step 340 and the model is retrained with the updated training sets.

In embodiments, the data labeling process is repeated or iterated for several cycles (or stages) until enough websites are confidently labeled based on the above auto-labeling criteria.

In embodiments, the evaluation and iteration are halted once the benefit in accuracy approaches a threshold despite further training of the model using additional examples, or high value data points.

Lastly, per step 350, the comprehensive labeled data set is saved. In embodiments, the data set is saved to a CSV file where each row comprises a name or id, website, the text, and label.

### Production Model Training

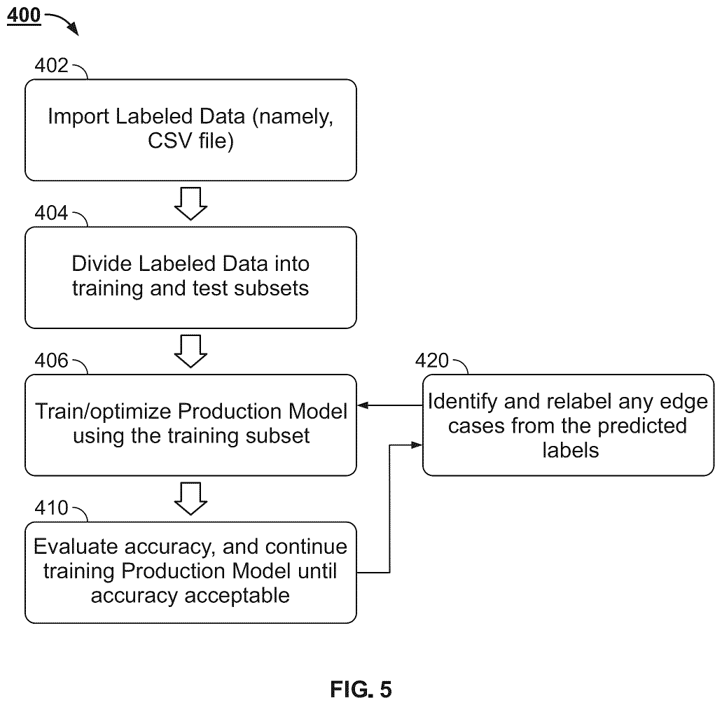

With reference to FIG. 5, a process 400 for training a candidate production model is described in accordance with embodiments of the invention.

Step 402 states to import the labeled data. This step is performed by importing the comprehensive labeled data set described above in connection with the data labeling process 300. Typically, the labeled data is in the form of a CSV file, perhaps 5,000 or more rows of data including the entity name, website, extracted text, and label.

Step 404 states to divide the labeled data into a training and test set. For example, the data set may be divided into 5 groups (or 5 folds), 4 of which are used for training and one for testing.

Step 406 states to train the production model using the training data set. In embodiments, one production model is selected from the data labeling process 300, described above. In embodiments, the data labeling model having the highest accuracy for the greatest number of categories is selected as the production model for fine tuning and optimization. A preferred production model is the gradient boosting or extreme gradient boosting (XGBoost) ML model.

After a production model has been selected, it is tuned and optimized. Most models commence with a set of default tuning parameters. Examples of tuning parameters for the XGBoost ML model include, e.g., general parameters, booster parameters and task parameters.

In embodiments, general parameters include setting the type of booster to a tree-based model.

In embodiments, exemplary tree booster parameters include:
a. eta (alias: learning_rate)=0.3
b. gamma (alias: min_split_loss)=0
c. max_depth (maximum depth of a tree)=6
d. min_child_weight (minimum sum of weights of all observations required in a child)=1; max_delta_step=0
e. subsample (denotes the fraction of observations to be randomly samples for each tree)=1.
f. colsample_bytree, colsample_bylevel, colsample_bynode=1. This is a family of parameters for subsampling of columns.
g. lambda (alias: reg_lambda)=1.
h. alpha=0, alias: reg_alpha. This is the L1 regularization term on weights (analogous to Lasso regression).
i. tree_method tree_method string=auto. This is the tree construction algorithm used in XGBoost.
j. scale_pos_weight scale_pos_weight t=1. It controls the balance of positive and negative weights.
k. max_leaves max_leaves t=0. This is the maximum number of nodes to be added.

In embodiments, learning task parameter tuning includes setting the loss function to be minimized to regression with squared loss.

It is to be understood the above tuning parameters represent a set of exemplary tuning parameters of one embodiment of the invention and that the type of turning parameters used, and/or the values set for each tuning parameter may vary widely. Some parameters arise based on the type of model employed, and the values are set by default. Some tuning parameters are set and evolve as the model is trained. Indeed, the above is intended to illustrate exemplary parameters which can be applied in the XGBoost ML model.

Training and optimizing the model is continued for the labeled training data set and labeled test data set. Typically, training includes cross validation by switching the training and test sets and retraining through multiple stages.

Step 410 states to evaluate accuracy of the production model.

If the accuracy is acceptable, for example, if 95% or more of the predicted labels match the true labels, then the production model is saved.

However, and with reference to Step 420, if the desired accuracy or loss function is not sufficient, training is continued. As described herein, training may be improved by adding more labeled data points to the low count categories, relabeling predictions having low accuracy, and/or further tuning some of the model(s) parameters.

### EXAMPLES

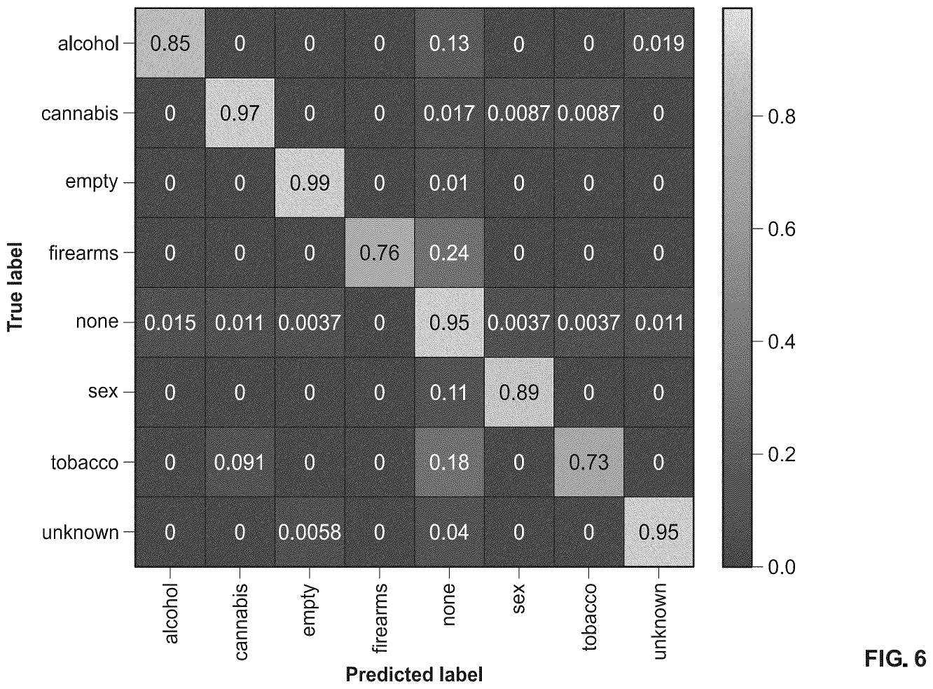

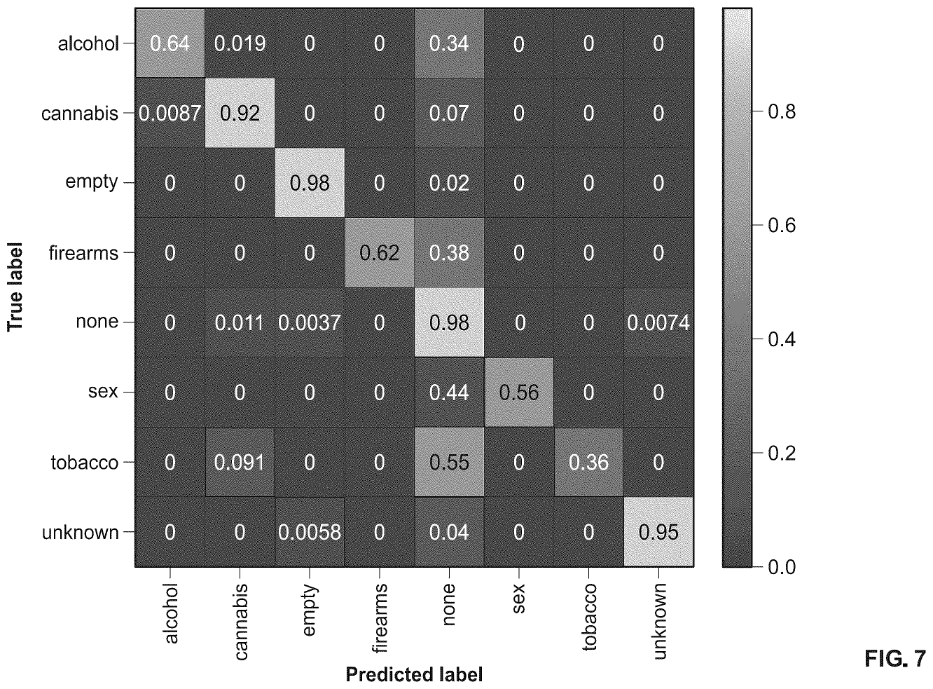

FIGS. 6-7 illustrate results of a XGBoost and Random Forest ML model, respectively. In each case, a labeled data set was prepared from 7500 websites. Each ML model was trained on 6000 websites and tested on 1500 websites. The text was extracted from the websites and parsed using a text extracting tool such as Beautiful Soup. The parsed text was vectorized using a vectorizer such as TF-IDF and then input to the model. The charts shown in FIGS. 6-7 reflect accuracy of the 1500 predicted labels versus the actual or true labels.

With reference to FIG. 6, the XGBoost ML Model, except for tobacco and firearms having the scores at 0.73 and 0.76 respectively, showed good results across all the categories (e.g., upwards of 85%). Tobacco had a lower score in part due to its very small sample (approximately 114 websites), as well as the challenging overlap between this category and the cannabis category. Tobacco had 10% of misclassifications in the cannabis category. Firearms also had a relatively low score and we acknowledge that the firearms category is a challenging category because of the inherent ambiguity in the guidelines for what constitutes firearms (such as holsters, accessories, gun safes, etc.) as well as the broad overlap in fishing/outdoor supplies stores which do/do not sell firearm related equipment.

With reference to FIG. 7, the Random Forest ML model also had several accurate categories. However, many categories were not accurate. Particularly, alcohol, sex, tobacco, and firearms are below 0.7, with tobacco only predicting the true label 0.36 of the times. Although the Random Forest ML model may suffice for certain categories, namely, cannabis, it is not preferred for many of the other SHAFT categories.

Without intending to be bound to theory, the lower accuracy arises at least in part due to unbalanced data-tobacco and sex companies collectively made up less than 0.5% of the population of the data set. Because of this disparity in the data, embodiments of the invention select types of ML models which perform well using unbalanced data (e.g., XGBoost, SVM).

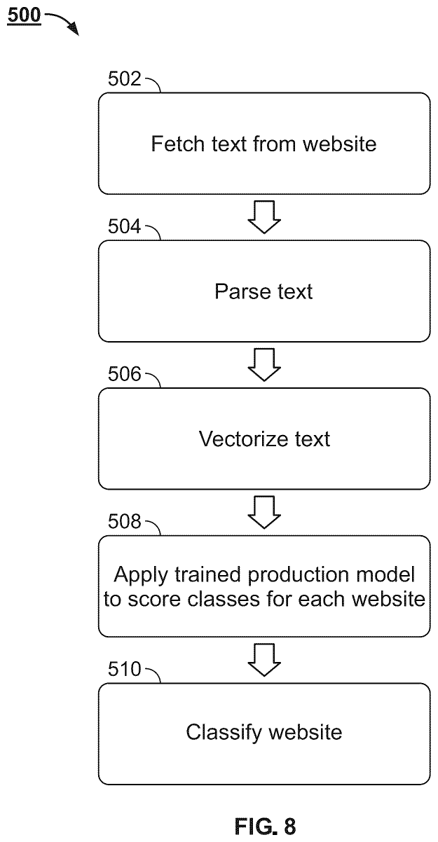

FIG. 8 is a flow chart of a classifying process to label unlabeled real websites, according to one or more embodiments of the present invention;

Step 502 states to fetch the website. Fetching may be performed by Python's request library using, e.g., a get request.

Step 504 states to parse the text. As described herein, the new website text is parsed using a parsing tool. A wide variety of parsing tools are available to carry out this step. In preferred embodiments, this step is carried out using Beautiful Soup.

Optionally, the text can be preprocessed. Preprocessing the text can include, without limitation, omitting/stopping certain words, stemming words, and/or changing the case of the letters (e.g., changing all uppercase letters to lowercase letters).

Step 506 states to vectorize the text. This step can be performed by the computing system using a vectorizer. While various vectorizers may be employed, in embodiments, the method uses the Term frequency-inverse document frequency (TF-IDF) model. The TF-IDF is a measure of importance of a word to a document in a collection or corpus, adjusted for the fact that some words appear more frequently in general.

The TF-IDF has several parameters which may be adjusted or set. In embodiments, adjusted TF-IDF parameters include the total feature/word count and the minimum and maximum document frequency that a word should have to be used as a feature.

In a preferred embodiment, the total feature/word count is limited to less than 5000, and more preferably less than 4000 words.

The minimum and maximum document frequency (min_df, max_df) limits the frequency that a word should have to be used as a feature. The frequency here refers to the proportion of documents. Both parameters have to be set in the range of [0,1] or 0 and 100%. If it is desired to remove more common words, the max_df is set to a lower ceiling value between 0 and 1. If it is desired to remove more rare words, the min_df is set to a higher cutoff value between 0 and 1.

In embodiments, the minimum document frequency that a word should have to be used as a feature (namely, the min_df) is set to range between [0.0003-0.001] or 3 out of 7500 websites.

In embodiments, maximum document frequency that a word should have to be used as a feature (namely, the max_df) is set to range between 25 to 75% and more preferably between 33 to 66% and in preferred embodiments between 40-50%, or between [0.40-0.50].

As indicated above in connection with the results illustrated in FIG. 6, these vectorizer parameters worked well when applied to the XGBoost ML model.

Step 508 states to apply the trained production model to score each of the classes for the website. Examples of classes include sex, hate, alcohol, firearms, tobacco, cannabis (collectively referred to as the “SHAFT” categories), non-SHAFT (or also referred to as the ‘none’ category), and unknown (i.e., the model is unable to make a prediction for any category and manual review would be required to confirm for SHAFT compliance).

There are several reasons a category may be classified as unknown. Exemplary reasons for classifying a website as ‘unknown’ include that the site is in a foreign language which is not covered by the vocabulary of the model; the site contains too many unknown terms; or the model isn't receiving enough content to be able to make a prediction. Insufficient content can arise because the website landing page does not provide enough content; the scraper is not operable to scrape with the particular website (e.g., some scrapers cannot gather the text from a ‘rendered’ website); the content is all in images; or the content is otherwise in an inaccessible format for the scraper to gather.

In preferred embodiments, the score of each category represents a fraction of the whole where the sum of the scores is equal to 100%.

Step 510 states to classify the new website. In embodiments, the entire website is classified based on the computed scores from step 508. In a preferred embodiment, the website is classified according to the category receiving the highest score in step 508.

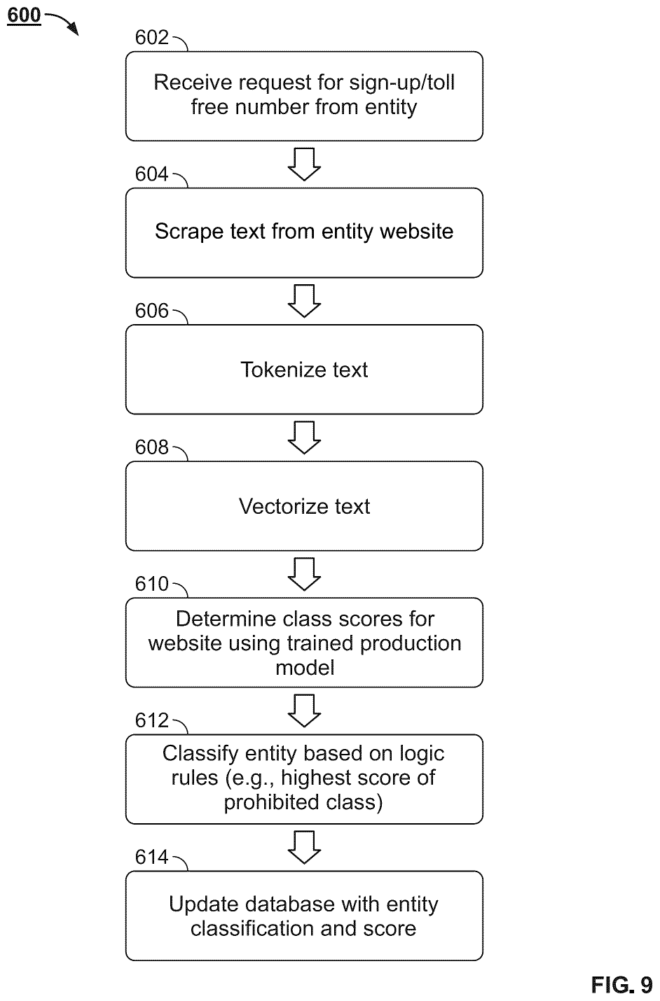

FIG. 9 is a flow chart of a classifying process 600 to label a new entity, according to one or more embodiments of the present invention.

Step 602 states receive request from a new entity to sign-up, or to use a toll-free number (TFN) or short message service (SMS). This step can be performed by the compliance check module 142 as described above in connection with FIG. 1. Once a request is received from the entity computing device 120, the compliance check module 142 commences the entity classification process 600.

Steps 604 states to scrape the website. This step can be performed as described above in connection with process 500.

Step 606 states to tokenize the text. This step can be performed using a tool that is operable to tokenize the text. Exemplary tools for tokenizing the text are described above in connection with process 500.

Step 608 states to vectorize the text. This step can be performed as described above in connection with process 500. In embodiments, the steps of tokenizing and vectorizing are performed by one tool, such as, for example, the TF-IDF tool.

Step 610 states to determine class scores for the new website using the trained production model. In embodiments, sex, hate, alcohol, firearms, tobacco, cannabis, none (i.e., non-SHAFT), empty (e.g., website not available), and unknown are scored. In preferred embodiments, the score of each category represents a fraction of the whole where the sum of the scores is equal to 100%.

Step 612 states to classify the entity based on the logic rules. In embodiments, the entity website is classified based on the computed scores from step 610. In a preferred embodiment, the entity website is classified according to the category receiving the highest score in step 610. The entity is then classified based on the classification of the website.

Optionally, in embodiments, the logic rules include additional factors such as, for example, (a) self-reporting data (e.g., the compliance check module can be programmed and operable to ask entity for its classification from a drop down listing), (b) publicly available information including state of incorporation, number of years in business, number of employees, existence and status of business licenses (e.g., pending alcohol license), and (c) text present in the entity name or website URL (e.g., cannabis.com). Scores may be adjusted based on the additional factors, increasing or decreasing (or overruling) the classification score. For example, if an entity is found to have a liquor or cannabis license, it can be labeled accordingly despite the initial classification score.

Step 614 states to update the database with the entity's classification and score from step 612. This information can be saved, e.g., on the SHAFT database 170 of main server computing system 140, described above in connection with FIG. 1.

In embodiments, entities are prohibited from receiving TFN and SMS accounts if they are classified in a SHAFT, unknown, or empty class. In embodiments, if the entity is classified in the unknown or empty class, it would be prohibited from getting a TEN or SMS account until the website could be manually reviewed and approved.

In embodiments, the entire process 600 from receiving the request (step 602) to updating the database with the entity classification and score (step 614) can be implemented on commercially available hardware, examples of which are described herein, in under 30 seconds, and typically under 10 seconds. In some embodiments, speed is further improved by limiting the total length of inputted text (e.g., limit the inputted text to up to 2000 words). Another speed improving technique is to limit the vector length (e.g., reduce the vector length to 5000, more preferably to less than 4000, or in some embodiments to less than 2500). Additionally, in preferred embodiments, the steps are performed asynchronously and run in parallel. Thus, the server is not required to wait for one account request to be completed before starting to check another account request.

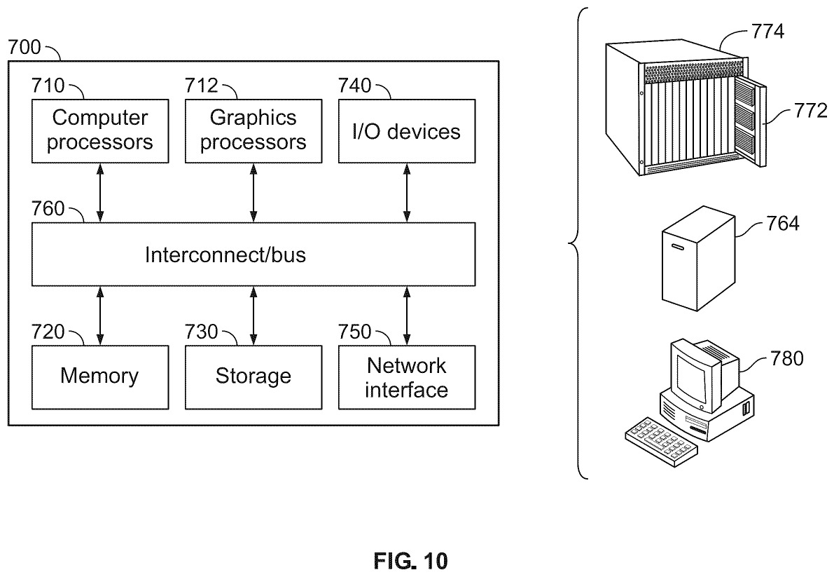

FIG. 10 is a block diagram of a computing system 700 used to implement the techniques/processes described herein in accordance with embodiments of the invention. The computing device 700 is intended to represent various forms of digital computers, such as servers, workstations, desktops, laptops, and other appropriate computers. The components shown here, their connections and relationships, and their functions, are meant to be exemplary only, and are not meant to limit implementations of the inventions described and/or claimed herein.

The computing device 700 is shown including: a computer processor 710, graphic processor 712, memory 720, storage 730, input output devices 740 and network interface 750.

The processors 710, 712, memory 720, storage 730, and network interface 750 are interconnected using various interconnect busses 760, and may be mounted on a common motherboard or in other manners as appropriate. The processor(s) can process instructions for execution within the computing device 700 to carry out the operations described herein, and including instructions stored in the memory 720 to display graphical information for a GUI on a display unit coupled to the network interface, I/O ports, or dedicated video card (not shown).

The memory 720 stores information within the computing device 700. In some implementations, the memory 720 is a volatile memory unit or units. In some implementations, the memory 720 is a non-volatile memory unit or units. The memory 720 may also be another form of computer-readable medium, such as a magnetic or optical disk.

The storage device 730 can provide mass storage for the computing device 700. In some implementations, the storage device 730 may be or contain a computer-readable medium, such as a hard disk device, an optical disk device, a tape device, a flash memory or other similar solid state memory device, or an array of devices, including devices in a storage area network or other configurations.

A computer program product may also contain instructions that, when executed, perform one or more methods, such as those described above. The computer program product can also be tangibly embodied in a computer- or machine-readable medium or media, such as the memory 720 or the storage device 730.

Examples of input/output devices 740 include without limitation, a keyboard, mouse or pointing device, and printer.

Network interface 750 can include various communication ports (e.g., USB, Bluetooth, Ethernet, wireless Ethernet).

The computing device 700 may be implemented in a wide variety of different forms. For example, it may be implemented as a standard server 764 or a desktop computer 780.

In some embodiments, multiple processors and/or multiple buses are combined, as appropriate, along with multiple memories and types of memory. Multiple computing devices may be connected, with each device providing portions of the necessary operations (e.g., as a server bank, a group of blade servers, or a multi-processor system). Examples of server systems for implementing the processes and methods described herein include, without limitation, cloud data centers with rack-mounted servers, blade server systems, etc.

In some embodiments, the classification method is implemented as a group of blade servers 772 housed in a blade server enclosure system 774. In some embodiments, a blade enclosure is operable to provide additional services such as power, cooling, networking, various interconnects and management.

### Alternative Embodiments

In alternative embodiments, a classifier is trained to classify an entity with additional non-SHAFT categories including, for example, gambling, pharma, crypto, etc. In such embodiments, the model is trained as described herein except the training data is labeled with the non-SHAFT categories. The trained model is then used to classify the entity based on the entity's website as described herein with reference to the classifier models described above.

In embodiments, where the candidate website is in a foreign language, the content is translated using a language translator model before being vectorized. In embodiments, a language detector detects the language, and the content is translated if not in the primary language. In embodiments, the primary language is English.

Throughout the foregoing description, and for the purposes of explanation, numerous specific details are set forth in order to provide a thorough understanding of the described techniques. It will be apparent, however, to one skilled in the art that these techniques can be practiced without some of these specific details. Although various embodiments that incorporate these teachings have been shown and described in detail, those skilled in the art could readily devise many other varied embodiments or mechanisms to incorporate these techniques. Also, embodiments can include various operations as set forth above, fewer operations, or more operations; or operations in another order than that specifically described above. Additionally, any of the components and steps described herein may be combined with one another in any logical manner except where such components or steps would be exclusive to one another. Accordingly, the scope and spirit of the invention should be judged in terms of the claims, which follow as well as the legal equivalents thereof.

What is claimed is:

1. A computer-implemented method of training a production model to classify prohibited entities comprising:
gathering text from a plurality of different entity websites;
preparing a first data set for a first stage of training by labeling a portion of the websites with a category from a group of prohibited categories;
providing at least one candidate label-assist model;
training the at least one candidate label-assist model during the first stage using the first data set to predict a category and a confidence score for each of the plurality of websites;
creating a second data set for a second stage of training by identifying and relabeling all websites having high confidence scores greater than a threshold value with the predicted category; and
training the at least one candidate label-assist model in a second stage of training using the second data set.

2. The computer-implemented method of claim 1, further comprising saving the second data set if the confidence scores for each of the categories reach a threshold value.

3. The computer-implemented method of claim 1, wherein the at least one candidate label-assist model comprises a plurality of candidate label-assist models, wherein the plurality of candidate label-assist models comprises different types of machine learning models.

4. The computer-implemented method of claim 3, further comprising selecting a production model from the plurality of candidate label-assist models based on the candidate label-assist model predicting categories having the highest confidence scores.

5. The computer-implemented method of claim 3, further comprising comparing the predicted categories computed by the plurality of candidate label-assist models for matching.

6. The computer-implemented method of claim 5, further comprising creating a third data set by labeling the websites with the predicted categories if the predicted categories computed by each of the plurality of candidate label-assist models match, and training the at least one candidate label-assist model during a third stage of training with the third data set.

7. The computer-implemented method of claim 5, further comprising identifying disputed-category websites where the predicted categories computed by each of the plurality of candidate label-assist models do not match.

8. The computer-implemented method of claim 7, further comprising creating a fourth data set by relabeling the disputed websites, and training the at least one candidate label-assist model during a fourth stage of training with the fourth data set.

9. The computer-implemented method of claim 1, further comprising identifying at least one low count category, and creating a fifth data set by relabeling the entities to increase the number of entities in the at least one low count category, and training the at least one label-assist model during a fifth stage of training with the fifth data set.

10. The computer-implemented method of claim 9, wherein the low count category is defined as a category made up of less than 10% of the labeled entities.

11. The computer-implemented method of claim 1, further comprising identifying edge data points having computed confidence scores below 50%, and creating a sixth data set for a sixth stage of training by relabeling the edge data points, and training the at least one label-assist model during a sixth stage of training with the sixth data set.

12. The computer-implemented method of claim 4, wherein the trained production model is decision tree based.

13. The computer-implemented method of claim 4, wherein the trained production model is gradient boosting.

14. The computer-implemented method of claim 3, further comprising fetching and parsing the text from the websites, and optionally by using Beautiful Soup.

15. The computer-implemented method of claim 4, further comprising vectorizing the parsed text.

16. The computer-implemented method of claim 1, further comprising creating a vector from an unlabeled website; and computing, using the trained machine learning production model, a score for at least one prohibited category for the unlabeled website.

17. A computing system for classifying an entity comprising:
one or more processors programmed and operable to:
generate, using at least one machine learning label-assist model through multiple training stages, a labeled production data set comprising a plurality of different entities, text, and a label for each entity;
train a machine learning production model using the labeled production data set; and
classify an unlabeled entity according to a prohibited category based on automatically gathering text from the entity's website and the trained machine learning production model.

18. The computing system of claim 17, wherein the one or more processors are programmed and operable to save the entity name and its prohibited category to a database for prohibiting TFN and SMS services.

19. The computing system of claim 18, wherein the one or more processors are programmed and operable to classify the entity as a non-shaft entity, an unknown entity, or an empty entity.

20. A computer-implemented method of classifying a prohibited entity comprising:
creating a vector from an unlabeled website of the entity; and
computing, using a trained machine learning production model, a score for at least one category for the unlabeled website based on the vector, wherein the at least one category comprises at least one prohibited category.
